(19) United States
(12) Patent Application Publication
(10) Pub. No.: US 2005/0120091 A1
(43) Pub. Date: Jun. 2, 2005

(54) Method, network device and system for providing profile data applicable to hypertext transfer protocol (http)

(76) Inventors: Eduardo Casais, Spiegel (CH); Valeri Atamaniouk, Helsinki (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/506,004

(22) PCT Filed: Mar. 4, 2002
(86) PCT No.: PCT/IB02/00628

(51) Int. Cl. G06F 15/16

(52) U.S. Cl. 709/217; 709/203

(57) ABSTRACT

The present invention is based on a concept to provide session and profile management for network communication, especially over hypertext transfer protocol (HTTP), employing available communication methods. Session and profile management is available and standardized for mobile communication by the means of the wireless session protocol (WSP) employable for wireless application protocol (WAP) communication. This wireless session protocol (WSP) is limited to mobile communication. The analog communication standard hypertext transfer protocol (HTTP) available and standardized for wireline communication does not offer a session and profile management. The present invention offers a method to establish an analog session and profile management by the means of cookies or modified uniform resource locators (URL) even over the hypertext transfer protocol (HTTP) without requiring substantial changes to the hypertext transfer protocol (HTTP) standard.

### CROSS-REFERENCE TO RELATED APPLICATION

This application is the U.S. National Stage of International Application Number PCT/IB02/00628 filed Mar. 4, 2002.

### BACKGROUND OF THE INVENTION

The present invention relates to a method, a network device and a system for providing profile data to a requesting device. In particular, the present invention relates to a method, a network device and a system for providing user agent profile (UAProf) information on the basis of cookies or modified uniform resource locators (URL) for coding and communicating information relating to a cached user agent profile (UAProf).

As WEB- and WAP-enabled devices come of age, an assumption of device homogeneity within the respective group of WEB- and WAP-enabled devices is no longer universally valid. The Internet world is rapidly growing, beyond the personal computer (PC) world, into the consumer home market. A variety of Internet information appliances are already put into the market, and seem to spread very far. Examples of Internet information appliances are Internet-TVs, set-top-boxes, home word-processors, personal digital assistants (PDA), smart phones, and car navigation systems. In particular, mobile devices can be expected to have an ever-divergent range of input and output capabilities, such as number of displayed colors, and different form-factors of keyboards, network connectivity, levels of scripting language support, and the like. Moreover, users may have content presentation preferences that also cannot be transferred to the server for consideration. As a result of this device heterogeneity and of the limited ability of users to convey their content presentation preferences to the server, clients may receive content that they cannot store, that they cannot display, that violates the desires of the user, or that takes too long to convey over the network to the client device.

Work is ongoing in the World-Wide-Web Consortium (W3C) to define mechanisms for describing and transmitting information about the capabilities of Web clients and the display preferences of Web users. The composite capabilities/preferences profile (CC/PP) specification defines a high-level structured framework for describing this information; the composite capabilities/preferences profile (CC/PP) is coded within the header of the HTTP/1.0 and HTTP/1.1 header with a compatible straightforward extension. CC/PP profiles are structured into named “components,” each containing a collection of attribute-value pairs, or properties. The mechanism by which the profile is transported between the mobile terminal, WEB proxies and servers is defined in this specification.

The user agent profile (UAProf) specification extends WAP 1.x and WAP 2.0 to enable the end-to-end flow of a user agent profile (UAProf), also referred to as capability and preference information (CPI), between the WAP client, the intermediate network points (such as WAP gateways and WEB proxies), and the origin server. It seeks to inter-operate seamlessly with the emerging standards for composite capability/preference profile (CC/PP) distribution over the Internet. It uses the CC/PP model to define a robust, extensible framework for describing and transmitting CPI about the client, user, and network that will be processing the content contained in a WSP/HTTP response. The specification defines a set of components and attributes that WAP-enabled devices may convey within the CPI. This CPI may include, but is not limited to, hardware characteristics (screen size, color capabilities, image capabilities, manufacturer, etc.), software characteristics (operating system vendor and version, list of audio and video encoders, etc.), application/user preferences (browser manufacturer and version, markup languages and versions supported, scripting languages supported, etc.), WAP characteristics (WML script libraries, WAP version, WML deck size, etc.), and network characteristics (bearer characteristics such as latency and reliability, etc.). This specification seeks to minimize wireless bandwidth consumption by using a binary encoding for the CPI and by supporting efficient transmission and caching over WSP in a manner that allows easy interoperability with HTTP.

As a request travels over the network from the client device to the origin server, each network element may optionally add additional profile information to the transmitted CPI. These additions may provide information available solely to that particular network element. Alternatively, this information may override the capabilities exposed by the client, particularly in cases where that network element is capable of performing in-band content transformations to meet the capability requirements of the requesting client device. Origin servers, gateways, and proxies can use the CPI to ensure that the user receives content that is particularly tailored for the environment in which it will be presented. Moreover, this specification permits the origin server to select and deliver services that are appropriate to the capabilities of the requesting client.

The above presented drafts and specifications referring to composite capabilities/preferences profile (CC/PP) and user agent profile (UAProf), respectively, exhibits a number of disadvantages concerning the involved terminal devices, intermediate network devices, such as proxies and gateways, and servers.

The wireless session protocol (WSP) allows WAP-enabled clients to establish a session mechanism for managing the communication of the user agent profile (UAProf). Upon initiating a WSP session with e.g. a WAP gateway, the UAProf-aware client transfers its profile information within a WSP connect request. Upon receiving the profile information, a WAP-gateway that is aware of the UAProf capability caches the CPI, which will be effective for the lifetime of the session. The client may update the UAProf or resume or suspend the session on corresponding requests. To request content of a server during a WSP session, the client issues a standard WSP request to the WAP-gateway. The WAP-gateway is responsible for forwarding this WSP request to the designated origin server (typically via HTTP). In forwarding the request, the WAP-gateway must include the cached CPI associated the corresponding WSP session. The origin server receives the HTTP request, resolves the CPI, and generates a response along with a profile-warning header indicating whether the CPI was taken into account as the content was generated. The WAP gateway forwards the content to the client device over WSP, encoding the profile-warning header for efficient transmission over the wireless network.

Whereas the CPI has to be included within each HTTP request in order to obtain a CPI-adapted response, the session mechanism of the WSP provides cached UAProf or CPI, respectively, demanding a communication thereof only in case of the establishing of the session and/or in cases of required updates. In contrast to the concept of UAProf communicated via WSP, a CPI extended HTTP based network device connection wastes bandwidth. Moreover, the wasting of bandwidth concerns even wireless communication since UAProf capable clients employ wireless communication based on wireless profiled HTTP (W-HTTP) which is smoothly adapted to the requirements of the wireless communication. UAProf capable clients have to transmit CPI data in each W-HTTP request that is made corresponding to the mechanism of CPI handling described above in connection with HTTP server requests.

Further, included CPI in HTTP requests has to be processed by each gateway, proxy and server effected by the included CPI data. The processing of the CPI or UAProf data, respectively, includes, but is not limited to, parsing of the corresponding HTTP fields, validating the sequencing and MD5 digest, resolving the complete profile according to the rules stipulated in the CPI or UAProf standard, respectively, and updating the resulting profile. This profile processing and resolution is a complex and heavy operation, which should be avoided if possible. A session management provides the advantage that the processing of the CPI or UAProf data, respectively, has only to be performed in case of a changing in the CPI or UAProf data, respectively, which occurs at the initiating of the session and in connection with an update of the CPI or UAProf data, respectively.

A UAProf-aware client may introduce differences of its standard profile. Employing HTTP based communication, the introduced differences must be communicated in addition to the standard profile included in each HTTP request. Therefore, the client has to store information about the introduced differences as long as they are relevant. A session management relieves the client of storing this kind of information and this is of particular interest in combination with mobile clients of limited memory capacity.

Even the current realization of the WSP concept exhibits a number of disadvantages concerning the usability and the ability of implementing. The session information essential for providing a session management according to the description above is available only at the WSP protocol level, which is just one level above the transport layer. The session and UAProf support relate to the application level. The access to information of the WSP protocol level from the application layer is only possible when all components of the session management are implemented in one dedicated processing device. The necessary tight coupling between the required WSP and UAProf implementation makes it difficult to provide modular, flexible and efficient systems. Further, even when the WSP session concept is implemented, e.g. within a WAP-gateway, the communication to serving network devices requested by a client is preferably communicated over a session-less HTTP communication leg. The corresponding network devices are subject to all of the aforementioned disadvantages.

### BRIEF SUMMARY OF THE INVENTION

The object of the present invention is to provide cached profile data for the generation of request responses, preferably of WEB/WAP servers. A session management module may manage the profile data. The presented solution is applicable not only to hypertext transfer protocol (HTTP) and its wireless variant W-HTTP, but also to the wireless application protocol (WAP) establishing a session mechanism analog to the wireless session protocol (WSP). The session management according to the present invention further provides an applicable end-to-end session management mechanism, offering the advantages to all participating devices of the end-to-end chain. Correspondingly, a method, a device and a system for providing profile data is provided.

The object of the present invention corresponding to the provided method, device and system for providing profile data is solved according to the description that follows below.

According to an embodiment of the present invention, a method for providing profile data is provided. Preferably, the profile data may be CPI or UAProf information. The profile data are cached in order to be retrieved. These profile data are uniquely assigned to a requesting device, such as a client device. In a first operational step a request and an associated cookie are received. The request may comprise instructions for a serving device in order to initiate the generation of a corresponding response transmitted back to the requesting client comprising data in accordance with these instructions. The cookie comprises information that is used for retrieving profile data. Preferably, the comprised information represents a unique indicator or pointer to the profile data, respectively, which are advantageously assigned uniquely to the requesting device. In a following step, the profile data are retrieved correspondingly e.g. from a dedicated profile data cache. In a further step, a response in accordance with the request is generated. The generation of the response may take account of the profile data, especially the UAProf, in order to meet the needs and requirements of the requesting device and the request generating application regarding the UAProf information. A response cookie may additionally be generated comprising signaling information according to the generation of the response and update information according to the profile data caching. In a final step the response and, if generated, the cookie, are transmitted back to the requesting device.

According to an embodiment of the present invention, a method for providing profile data is provided. Preferably, the profile data may be CPI or UAProf information. The profile data are cached in order to be retrieved. These profile data are uniquely assigned to a requesting device, such as a client device.

In a first operational step a request from a requesting device is received. The request may comprise instructions for a serving device in order to initiate the generation of a response transmitted back to the requesting client comprising data in accordance with these instructions. Each request contains an address coding the requested data. In combination with WEB/WAP server a uniform resource locator (URL) is used for coding the address. Herein the request contains a modified uniform resource (URL) locator addressing a certain source (a server and content of this server) and comprising information for retrieving profile data. Preferably, the comprised information represents a unique indicator or pointer to the profile data, respectively, which are advantageously assigned uniquely to the requesting device. The modified uniform resource locator (URL) may be composed of the original uniform resource locator (URL) and a sequence coding the information to be retrieved appended to the original unmodified uniform resource locator (URL). Both the original uniform resource locator (URL) and the sequence coding the information may be separated easily. The coding may not interfere with the original purpose of the uniform resource locator (URL). In a following step, the profile data are retrieved correspondingly e.g. from a cache. In a further step, a response in accordance with the request is generated. The generation of the response may take account of the profile data, especially the UAProf, in order to meet the needs and requirements of the requesting device and the request generating application regarding the UAProf information. The resulting response may contain a plurality of uniform resource locators (URLs) referring to further content of a server, usually designated as links or hyperlinks. These uniform resource locators (URLs) are modified by appending information for retrieving the aforementioned cached profile data. The resulting modified uniform resource locators (URLs) are of the same type described above in connection with the uniform resource locator (URL) contained in the request. In a final step the response is transmitted back to the requesting device. A selection of one of the modified uniform resource locators (URL) comprised in the response may lead to a request in the same manner as described in the current embodiment.

According to an embodiment of the present invention, the caching of the profile data to be provided for retrieving may be based on a session concept, which means that the profile data are available to be retrieved during a certain period of time. This period of time may be termed a session. The profile data session may be established by an initial procedure leading to the caching of profile data and the generation of information necessary for the retrieval thereof, and the unique assignment to a requesting device. An initial request may establish the profile data for retrieving. Therefore, the initial request has to comprise the profile data to be cached in order to be retrieved by any subsequent request comprising information for retrieving. The caching of the profile data or the profile data session may be terminated by removing the profile data from the cache, respectively. The removing may be operated at the end of a period of time passed by, for example relating to the last request.

The session concept may require additional information to be communicated from the requesting client. This additional information may be a session identifier, preferably, a session-identifying sequence. The additional information may be comprised in the information for retrieving. According to an embodiment of the method of the present invention, the above described received cookie may comprise information for retrieving profile data relating to the requesting client and may comprise information identifying the associated session relating to the profile data and the requesting client. Analogously, according to an embodiment of the method of the present invention, the above described modified uniform resource locator (URL) may comprise information for retrieving profile data relating to the requesting client and may comprise information identifying the associated session relating to the profile data and the requesting client for example both appended to the original uniform resource locator (URL).

According to an embodiment of the present invention, the step of generating the response may further comprise a step of generating a server response, transmitting the server response to a serving device and receiving a corresponding server response. The server request is based on the instructions and information comprised by the client response. Correspondingly, the server response is based on the server request and hence is based on the original request received from the requesting device.

According to an embodiment of the present invention, the request of the requesting device may be a request addressed to a WEB/WAP-server requesting content of this WEB/WAP-server. Correspondingly, the response generated in accordance with the request may be a WEB/WAP-server response.

According to an embodiment of the present invention, the method for providing profile data may be applicable to the hypertext transfer protocol, which is employed for coding the request and the response for communicating over a communication network. Additionally, the providing of profile data may be applicable to the wireless application protocol (WAP).

According to an embodiment of the present invention a software tool for providing profile data is provided. The software tool comprises program portions for carrying out the operations of the aforementioned methods when the software tool is implemented in a computer program and/or executed.

According to a further embodiment of the present invention a computer program for providing profile data is provided, comprises program code section for carrying out the above operations of the above methods for providing profile data when said program is run on a computer or a network device.

According to a further embodiment of the present invention a computer program product for providing profile data is provided comprising program code section stored on a computer readable medium. The computer program code sections are for carrying out the above mentioned method for providing profile data when said program product is run on a computer or network device.

According to a further embodiment of the present invention a network device for providing and managing profile data and session information is provided. The network device comprises a communication interface, a session manager and a serving component. The communication interface provides the ability to communicate to a requesting device by receiving and/or transmitting requests and responses, respectively. Additionally, cookies associated with these requests and responses are also communicated. The session manager manages the profile data. Therefore, a dedicated cache for caching profile data may be accessible by the session manager. The session manager is enabled to retrieve the profile data from this cache in accordance with information comprised in a received cookie referring to profile data. For this, the session manager may decode received cookies which are associated to a request and which comprise information for retrieving profile data. The retrieved profile data are supplied to the serving device. The serving device generates a response based on the received request. The generation of the response is further based on the supplied profile data. The profile data comprises CPI and UAProf information, respectively, representing abilities of the requesting device that may have to be taken into consideration in combination with the generation of the responses. The network device according to an embodiment of the invention is adapted to operate the aforementioned methods for providing profile data in connection with an associated cookie comprising information for retrieving the profile data.

According to a further embodiment of the present invention a network device for providing profile data is provided. The network device comprises a communication interface, a session manager and a serving component. The communication interface provides the ability to communicate to a requesting device by receiving and/or transmitting requests and responses, respectively. A received request comprises a modified uniform resource locator (URL) including the original uniform resource locator (URL) and information for retrieving profile data. The session manager manages the profile data. Therefore, a dedicated cache for caching profile data may be accessible by the session manager. The session manager retrieves these profile data by the referring and session information and supplies the profile information to the serving component. The session manager may decode modified uniform resource locator (URL) in order to obtain the information for retrieving. The serving device generates responses based on the received requests. The generation of the response is further based on the supplied profile data. The profile data may comprise CPI and UAProf information, respectively, representing abilities of the requesting device that may have to be taken into consideration in combination with the generation of the responses. Further the serving component processes the original uniform resource locators (URLs) included in the generated response. The original uniform resource locators (URLs) are modified by appending information for retrieval of the profile data. The network device according to an embodiment of the invention is adapted to operate the aforementioned methods for providing profile data in connection with a modified uniform resource locator (URL) comprising information for retrieving the profile data.

According to a further embodiment of the present invention the serving component of the network device may be able to generate a server request. The communication interface may transmit this server request to the server and may receive subsequently a server response based in the server request. The generation of response for the requesting device may take account of the response of the server.

According to a further embodiment of the present invention the network device may be a server network device, Conveniently, network device may be a proxy network device or a gateway network device.

According to a further embodiment of the present invention a system for providing profile data is provided. The system comprises a requesting device and a network device. The network device is a network device according to an embodiment of the network device of the present invention; in particular, the network device is a server network device. Correspondingly, the network device may be able to operate according to an embodiment of the method of the present invention. The requesting device may be able to generate a request according to the requirements and needs of an embodiment of the method of the present invention.

The system may allow operating the following operational steps. In a first step, requesting device may generate a request and transmit the request to the network device. The network device may receive the request. The request comprises information for retrieving profile data. The information may be contained in a cookie associated with the request and transmitted to the network device, and received thereby. Alternatively, the information may be comprised within a modified uniform resource locator (URL) like that described above. Preferably, the profile data may be uniquely assigned to the requesting device and are cached by a cache associated to the network device. In a further step, the profile data may be retrieved in accordance with the information contained in the cookie and may be supplied for generating a response. The response may be generated by the network device based on the request and taking into account the profile data. The coding of the information for retrieving the response may be processed in case of a request containing a modified uniform resource locator (URL). Modified uniform resource locators (URLs) contained in the response may be processed by including information for retrieving according to an embodiment of the method of the present invention. Alternatively, a response cookie may be generated. In a final step the response and the cookie may be transmitted back to the requesting device and may be received by the requesting device.

According to a further embodiment of the present invention a system for providing profile data is provided. The system comprises a requesting device, an intermediate network device and a server. The intermediate network device is a network device according to an embodiment of the network device of the present invention, in particular, the network device is a proxy network device or a gateway network device. Further, the intermediate network device is able to operate according to an embodiment of the method of the present invention. The requesting device is able to generate a request according required by an embodiment of the method of the present invention. The server is able to provide a response based on the request of the requesting device. The requesting device communicates with the server via the intermediate network device.

The system may allow operating the following operational steps. In a first step, a requesting device may generate a request and transmit the request to the network device. The network device may receive the request. The request comprises information for retrieving profile data. The information may be contained in a cookie associated with the request and transmitted to the network device, and received thereby. Alternatively, the information may be comprised within a modified uniform resource locator (URL) like that described above. Preferably, the profile data may be uniquely assigned to the requesting device and are cached by a cache associated to the network device. In a further step, the profile data may be retrieved in accordance with the information contained in the cookie and may be supplied for generating a response. The response may be generated by the network device based on the request and taking account of the profile data. The generation of the response may involve generating of a server request, transmitting of the server request to the server and receiving of a server response in accordance to the server request. Corresponding to the coding of the information for retrieving the response may be processed in case of a request containing a modified uniform resource locator (URL). A plurality of uniform resource locators (URLs) comprised by the response may be processed by including information for retrieving according to an embodiment of the method of the present invention for obtaining corresponding modified uniform resource locators (URLs) for subsequent requests. Alternatively, a response cookie may be generated. In a final step the response and the cookie may be transmitted back to the requesting device and may be received by the requesting device.

Embodiments of the present invention will be further illustrated and explained to those of ordinary skill in the art after having read the following detailed description of the embodiments which are exemplified in the various drawing figures.

### BRIEF DESCRIPTION OF THE DRAWINGS

FIG. 1a shows a flow diagram illustrating a sequence of processing operations with respect to the operation of a server and a gateway, respectively, according to an embodiment of the invention,

FIG. 1b shows a flow diagram illustrating a sequence of processing operations with respect to the operation of a server and a gateway, respectively, according to an embodiment of the invention,

FIG. 2a shows a block diagram illustrating a system of a client and a server according to an embodiment of the invention,

FIG. 2b shows a block diagram illustrating a system of a client, a gateway and a server according to an embodiment of the invention,

FIG. 3a shows a flow diagram illustrating a timely sequence of the operations with respect to FIG. 2a and according to an embodiment of the invention,

FIG. 3b shows a flow diagram illustrating a timely sequence of the operations with respect to FIG. 2b and according to an embodiment of the invention,

FIG. 4a shows a flow diagram illustrating a sequence of processing operations with respect to the operation of a server and a gateway, respectively, according to an embodiment of the invention,

FIG. 4b shows a flow diagram illustrating a sequence of processing operations with respect to the operation of a server and a gateway, respectively, according to an embodiment of the invention,

FIG. 5a shows a block diagram illustrating a system of a client and a server according to an embodiment of the invention,

FIG. 5b shows a block diagram illustrating a system of a client, a gateway and a server according to an embodiment of the invention,

### DETAILED DESCRIPTION OF THE INVENTION

In the figures corresponding reference numerals denote corresponding features.

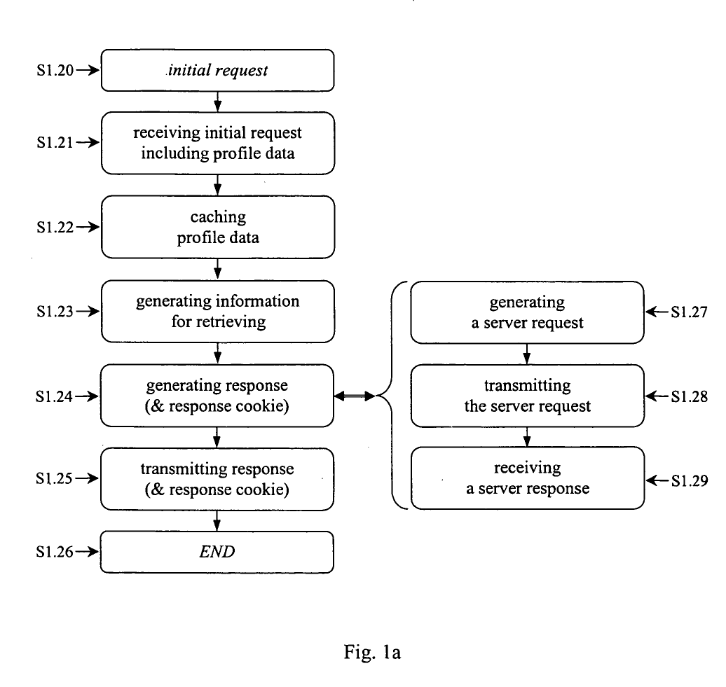

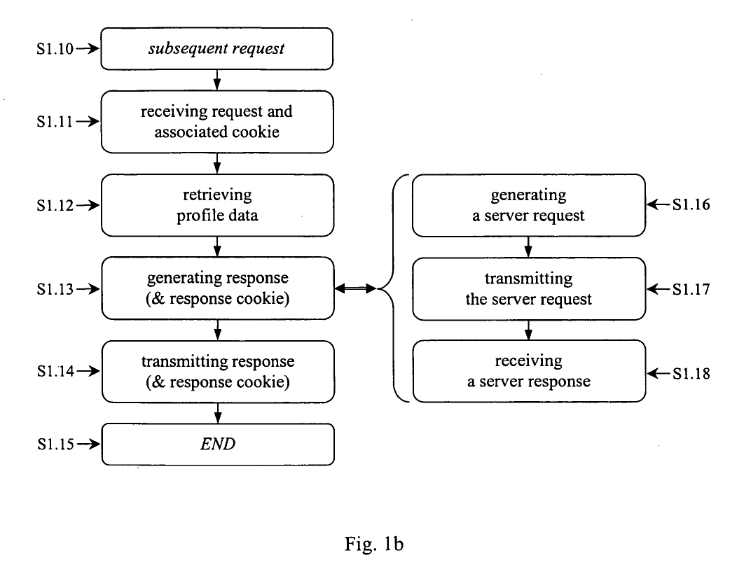

FIG. 1a shows a flow diagram illustrating a sequence of processing operations with respect to the operation of a server and a gateway, respectively, according to an embodiment of the invention. The sequence of processing operations illustrates the establishing of the profile data and session managing in accordance with an initial client request. Due to the inter-action of processing devices within an end-to-end communication chain, the concept of the present invention will be described with reference to a terminal client and a terminal server as also to a terminal client and an intermediate network device, i.e. an inter-acting gateway or proxy.

Client—Server Communication:

The following operations are dedicated to and operated by a server communicating with a client, both supporting the profile and session management according to an embodiment of the present invention.

In an operation S1.20, the initial request operation is started.

In an operation S1.21, a server receives an initial request. The initial request comprises, according to the description above, user agent profile (UAProf) information. The server recognizes on the basis of the comprised UAProf that a session has to be opened and the initial UAProf information has to be established.

In an operation S1.22, the initial UAProf information is cached. The UAProf information may be optionally modified by the server with additional server-related UAProf information, reflecting information only available to the server.

In an operation S1.23, referencing and session information is obtained. The referencing and session information comprises a code sequence by which the cached UAProf information is accessible and retrievable, i.e. this code sequence may be termed as a pointer pointing to the cached UAProf information. Further, the referencing and session information may additionally code a unique session identification, such that the server may identify a subsequent client request as belonging to this established session.

In an operation S1.24, a response in accordance with the client request is generated. For example, the client may request to access a certain WAP/WEB page provided by the server. Therefore, the request may comprise an identifier of this certain WAP/WEB page, usually a uniform resource locator (URL). The server may retrieve the indicated WAP/WEB page from its storage area and generates a corresponding request response. In order to inform the client of the established session and to put the client in the position to transmit a unique session identifying information upon subsequent requests to the same server, a cookie is generated. The cookie may preferably comprise the referencing and session information aforementioned with reference to operation S1.23. The coding of the aforementioned referencing and session information may further be completed by adding a signaling sequence in order to indicate for example that the caching operation has been performed, that the UAProf information has been taken into account during the generation of the request response or that the UAProf information has been rejected or the serving device is not able to take account of the UAProf information or parts thereof.

In an operation S1.25, the generated request response and the cookie are transmitted to the client.

In an operation S1.26, the operational sequence in accordance with the initial client request is finished.

Client—Gateway Communication:

The following operations are dedicated to and operated by an intermediate network device such as a gateway and a proxy, respectively, communicating with a client, both supporting the profile and session management according to an embodiment of the present invention. Advantageously, the description of the Client—Gateway Communication may distinguish between a server supporting the profile and session management according to an embodiment of the present invention, and a conventional server that does not support sessions.

In both cases, the intermediate network device operates the operations S1.20 to S1.23 in the same manner compared with the aforementioned operations S1.20 to S1.23 referencing to the Client—Server Communication. The operation S1.22 may comprise a modifying operation in accordance with the tasks of an intermediate negotiating network device, herein described with reference to an intermediate network device. The UAProf information may be optionally modified by the intermediate network device with additional server-related UAProf information, reflecting information only available by the intermediate network device, e.g. to better meet the needs of the requesting client. The operation S1.24 comprises a plurality of additional operations referring to the server communication.

Profile and Session Managing Server:

In an operation S1.27, a server request is generated. The generation of the server request may entail a conversion of the client request. The client request may be based on another transfer protocol as the server request. The information included in the client request may be taken over without modifying the content of the information. For example, a client request is received based on WAP and has to be forwarded to an HTTP based server. Correspondingly, the intermediate network device converts the client request. The comprised user agent profile (UAProf) information is maintained by the generating operation. In case of a prior modification of the UAProf described in operation S1.24, the modified user agent profile (UAProf) information may be included in the generated server request.

In an operation S1.28, the server request is transmitted to the server.

In an operation S1.29, a server request response is received. The server has preferably operated the operations S1.20 to S1.26 according to the aforementioned description referring to a server according to an embodiment of the present invention. Correspondingly, the server request response comprises a server response cookie. This server response cookie comprises referencing and session information of the UAProf caching and session managing of the server, and correspondingly may comprise a corresponding signaling sequence as described above.

In an operation S1.24, the intermediate network device generates a client request response based on the server response to the request. The generation may entail a conversion operation, e.g. to convert the server response information coded in a certain transfer protocol into a transfer protocol suitable for communication with the client. The generating operation may additionally take into account the UAProf information according to the version cached by the intermediate network device. For example, the cached UAProf information may be taken into account in case that the generated response does not fulfil all requirements of the client due to an incomplete considering of the UAProf information by the server, e.g. due to lacking server capabilities. Referencing and session information of both the intermediate network device, and the server is available. The referencing and session information relating to the server may be additionally cached by the intermediate network device to be retrieved alternatively to the UAProf of the client by the referencing and session information relating to the intermediate network device. Further, both referencing and session information may be coded in cookies and added to the client request response, or may be coded in a single cookie comprising the complete information, and added to the client request response.

In an operation S1.25, the generated request response and the cookie are transmitted to the client.

Non-Session Managing Server:

In an operation S1.27, a server request is generated. The generation of the server request is similar to the generating operation S1.27 described above with reference to the profile and session managing server.

In an operation S1.28, the server request is transmitted to the server.

In an operation S1.29, the intermediate network device receives the corresponding server response to the request. According to the capability of the server, the received server response may be based on the transmitted UAProf comprised in the server request, or the server may have not taken into account the provided UAProf.

In an operation S1.24, the generating operation may consider additionally the UAProf information according to the version cached by the intermediate network device. For example, the cached UAProf information may be taken into account in case that the generated response does not fulfil all requirements of the client due to an incomplete taking account of the UAProf information by the server, e.g. due to lacking server capabilities. Particularly, the intermediate network device may take the UAProf information during the generating operation into consideration in case of a server, which is not capable to take adequately the transmitted UAProf information into account. Further, the generating operation may code a cookie comprising referencing and session information according to the session management of the intermediate network device in a way analog to the aforementioned descriptions, especially in accordance with the operation S1.24 described in connection with the client—server communication.

In an operation S1.25, the generated request response and the cookie are transmitted to the client.

The following description with reference to FIG. 1b may describe the profile and session management with respect to subsequent client requests during an established session, according to the concept based on an embodiment of the present invention.

FIG. 1b shows a flow diagram illustrating a sequence of processing operations with respect to the operation of a server and a gateway, respectively, according to an embodiment of the invention. The illustrated sequence will be described in view of client—server communication and client—gateway communication analog to the description with respect to FIG. 1a.

Client—Server Communication:

In an operation S1.10, a subsequent request operation is started. A corresponding profile and session management is opened or established and the corresponding access information is available to client and server.

In an operation S1.11, the server receives a subsequent request from the client. The subsequent client request comprises a cookie. The cookie comprises referencing and session information. The session information and the referencing information allow the server to retrieve the information cached, i.e. the UAProf information transmitted at the establishment and opening of the corresponding client-related session. Therefore, referencing and session information identifies uniquely the client and references uniquely the cached UAProf information.

Additional control sequences may be included in the cookie comprising the referencing and session information. Control sequences may be used to indicate certain control functions of the session management. The client may update the cached information of a currently active session. Further, the client may suspend a currently active session or the client may resume a suspended session. To update the information cached by server, the client may transmit a request comprising the UAProf concerning information, i.e. the profile and the profile differences coded in the header of the request and an accompanying control sequence instructing the server to update the cached information. The session itself is maintained whereas the UAProf information is updated. Analogously, a session may be suspended. During the lifespan of an established session, the session managing and profile caching server has to cache all negotiated information relevant to session and profile. The suspended session does not entail parsing connected to the caching operation. Correspondingly, a control sequence may be issued to resume such a suspended session. The resume sequence forces an update operation of the cached profile to ensure that valid information is kept in the cache.

In an operation S1.12, the cached profile data are received. Particularly, cached UAProf information is retrieved.

In an operation S1.13, a response in accordance with the client request is generated. The generating operation takes into account the retrieved UAProf information by e.g. adapting or modifying the request response to meet the needs and requirements of the client defined in the UAProf information. Additionally, a cookie may be generated comprising status information taking into account the UAProf information. Further information with reference to the session managing may be included.

In an operation S1.14, the request response and the cookie are transmitted to the client.

In an operation S1.15, the operational sequence of a subsequent request during an established session and profile management is finished.

Client—Gateway Communication:

According to the following description, the operations S1.10 to S1.12 are operated by an intermediate network device such as a gateway and a proxy, respectively, in the same manner compared with the aforementioned operations S1.10 to S1.12 referencing to the Client—Server Communication.

Profile and Session Managing Server:

In order to identify the session managed by a subsequent server, the request or the cookie transmitted from the client may have to include additional referencing and session information in accordance with the profile and session managing of the server, in order to enable the retrieval of the profile data by the server. It may be further possible that this additional referencing and session information is cached additionally together with the profile data retrieved in the operation S1.12.

In an operation S1.16, a server request and a cookie is generated. The server request is based on the client request and the cookie comprises referencing and session information in accordance with the profile and session management of the server. The generating operation may be a conversion process analog to the operation S1.27 illustrated in FIG. 1a.

In an operation S1.17, the server request is transmitted to the server.

The following operations S1.18 and S1.13 are operated analogously to the operation S1.29 and S1.24 described in accordance with the Client—Gateway Communication section of the profile and session managing server.

In an operation S1.18, a server request is received. The server has preferably operated the operations S1.10 to S1.15 according to the aforementioned description referring to a server according to an embodiment of the invention. Correspondingly, the server response to the request comprises a server response cookie. This server response cookie comprises referencing and session information of the UAProf caching and session management of the server, and correspondingly may comprise a corresponding signaling sequence as described above.

In an operation S1.13, the intermediate network device generates a response to the client request based on the server response. The generation may comprise a conversion operation e.g. to convert the server response information coded in a certain transfer protocol into a transfer protocol suitable for communication with the client. The generating operation may additionally take into account the UAProf information according to the version cached by the intermediate network device. Referencing and session information of both the intermediate network device and the server is available. This Referencing and session information may be coded in two different cookies and added to the response to the client request, or may be coded in a single cookie comprising the complete information and added to the response. The corresponding information for subsequent accesses to the intermediate network device and the server is available to the client in both cases.

In an operation S1.14, the response to the request and the cookie are transmitted to the client.

Non-Session Managing Server:

The following operations S1.16 to S1.18 and S1.13 to S1.14 are operated analogously to the operations S1.27 to S1.29 and S1.24 to S1.25 described in accordance with the client—gateway communication section of a non-session managing server. Correspondingly, the description may be looked up above at the referenced section.

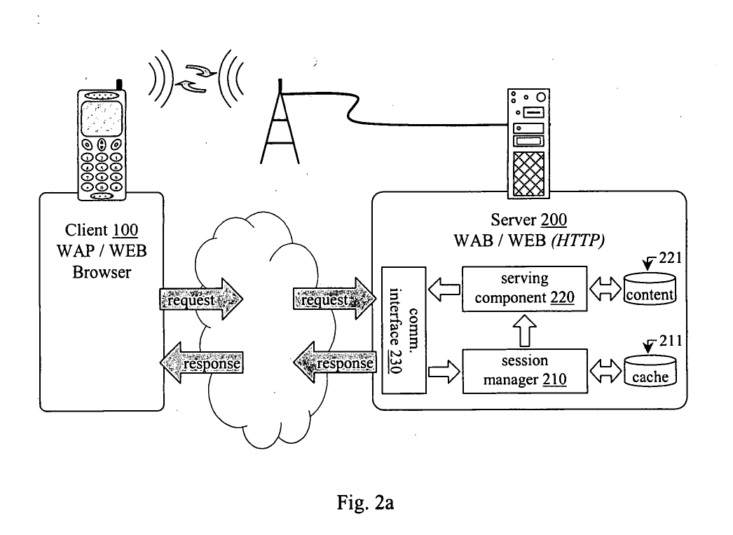

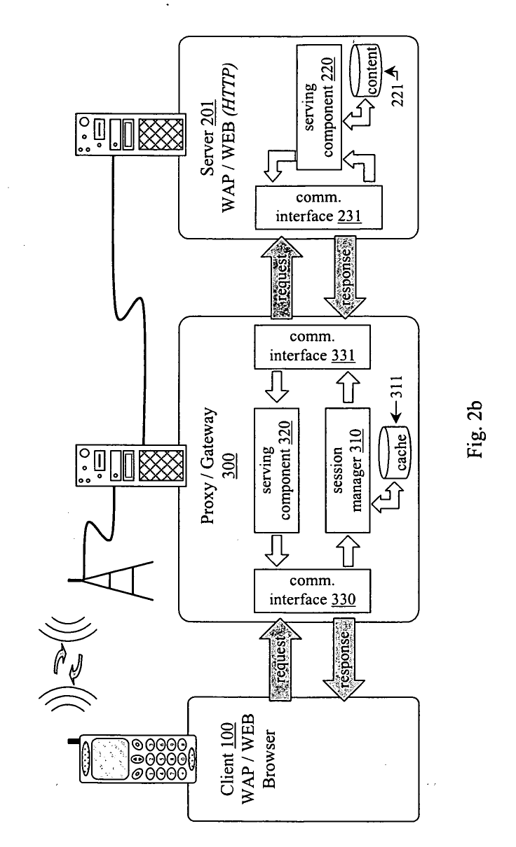

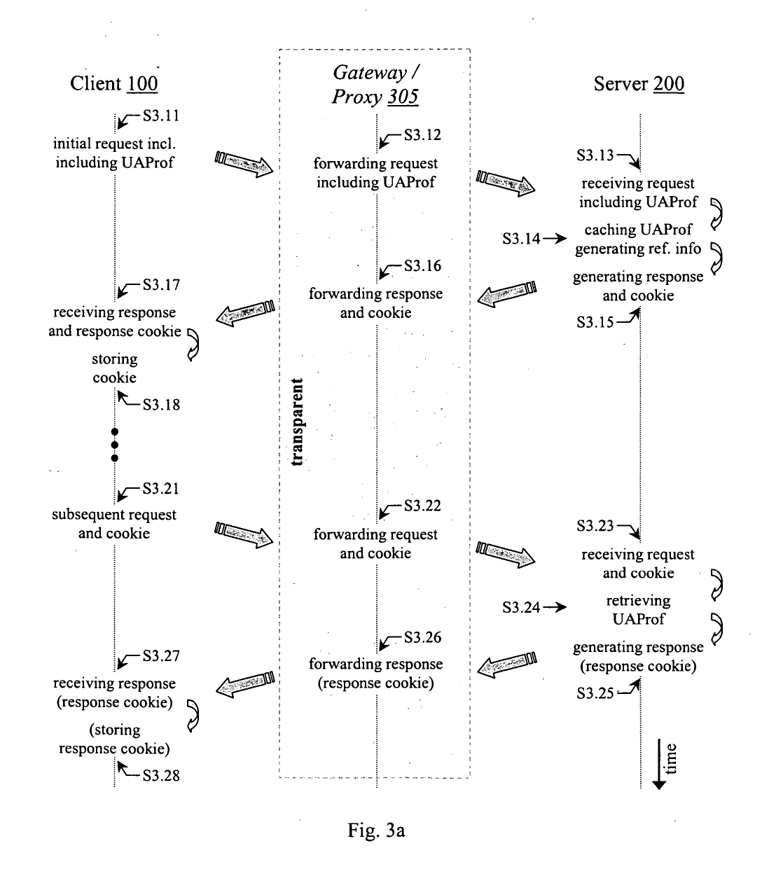

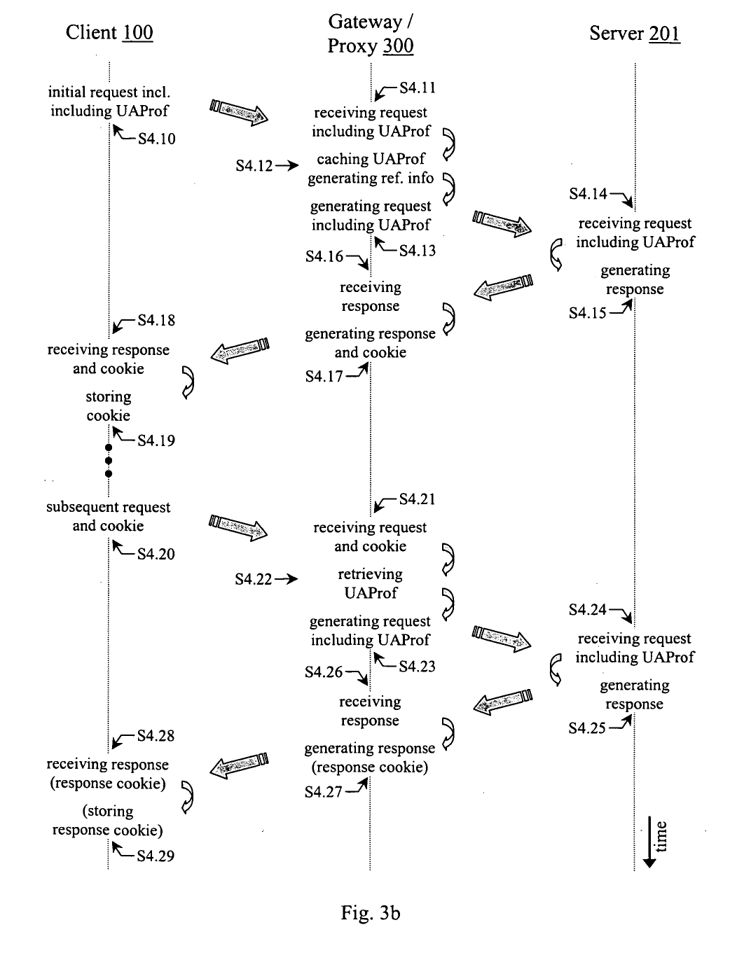

The following FIGS. 2a and 2b illustrate the plurality of apparatus and systems able to operate the aforementioned embodiments of the method according to the present invention. A detailed description of the interaction of the illustrated apparatus and systems will be given in combination with the following description of the FIGS. 3a and 3b.

FIG. 2a shows a block diagram illustrating a system of a client and a server according to an embodiment of the invention.

The client 100 may be a mobile terminal device, preferably a mobile phone. The mobile phone may operate a WAP/WEB browser. This browser is able to generate requests for a corresponding WAP/WEB server, e.g. requests requesting certain WAP/WEB pages, and is able to receive corresponding responses, e.g. responses comprising WAP/WEB pages to be displayed.

The server 200 may be the corresponding WAP/WEB server addressed by the client requests. The communication of the requests and the responses may be operated via communication networks, which may comprise a wireless communication network and a wireline communication network. Intermediate network devices (not shown) may be involved in the routing of the requests and responses. A WAP proxy or gateway may connect the wireless communication network and wireline communication network in order to convert the transfer protocols.

The server 200 comprises a communication interface 230, a session manager 210 for managing the session and cached information in a cache 211, and a serving component 220 for generating a response based on a client request. The serving component 220 may access a server content 221 providing data that may be requested by the client request.

The communication interface 230 may be constituted by a data processing device or a program section executed at the server 200 in connection to the client 100 via the above described communication network. The communication interface 230 may be realized by a server executable script or a program section executed at the server 200. The session manager 210 and the serving component 220 may be constituted by a data processing device or a program section executed at the server 200. The session manager 210 and the serving component 220 may be realized by a server executable script or a program section executed at the server 200.

FIG. 2b shows a block diagram illustrating a system of a client, intermediate gateway and a server according to an embodiment of the invention.

The client 100 may be a mobile terminal device, preferably a mobile phone. The mobile phone may operate a WAP/WEB browser. This browser is able to generate requests for a corresponding WAP/WEB server, e.g. requests requesting certain WAP/WEB pages, and is able to receive corresponding responses, e.g. responses comprising WAP/WEB pages to be displayed.

The server 201 comprises a communication interface 231, a serving component 220 for generating a response based on a client request. The serving component 220 may access a server content 221 providing data that may be requested by the client request.

The communication interface 231 may be constituted by a data processing device or a program section executed at the server 201 in connection to the proxy/gateway 300 via the above described communication network. The communication interface 231 may be realized by a server executable script or a program section executed at the server 201. The serving component 220 may be constituted by a data processing device or a program section executed at the server 201. The serving component 220 may be realized by a server executable script or a program section executed at the server 201.

The proxy/gateway 300 comprises a communication interface 330 enabling the communication with the client 100, and a communication interface 331 enabling the communication with the server 201. The communication interface 330 may allow communication with the client 100 via a transfer protocol adapted to wireless communication. The communication interface 331 may allow communication with the server 201 via a transfer protocol adapted to wireline communication. A common communication interface (not shown) may offer the functionality of both the communication interface 330 and the communication interface 331. Further, the proxy/gateway 300 comprises a session manager 310 for managing the session and cached information in a cache 311, and a serving component 320 for generating a response based on a client request and based on the server response.

The communication interface 330 may be constituted by a data processing device or a program section executed at the proxy/gateway 300 in connection to the client 100 via the above described communication network. The communication interface 330 may be realized by a server executable script or a program section executed at the proxy/gateway 300. The communication interface 331 may be constituted by a data processing device or a program section executed at the proxy/gateway 300 in connection to the server 201 via the above described communication network. The communication interface 331 may be realized by a server executable script or a program section executed at the proxy/gateway 300.

The session manager 310 and the serving component 320 may be constituted by a data processing device or a program section executed at the proxy/gateway 300. The session manager 310 and the serving component 320 may be realized by a server executable script or a program section executed at the proxy/gateway 300.

Further intermediate network devices (not shown) may be involved in the routing of the requests and responses.

FIG. 3a shows a flow diagram illustrating a timely sequence of the operations with respect to FIG. 2a and according to an embodiment of the invention. The operational sequence shown in FIG. 3a according to the apparatus and system illustrated in FIG. 2a corresponds to the client—server communication described in FIG. 1a and FIG. 1b. The following description may extend the above-presented description. Therefore, references back to the FIG. 2a will be given.

The operations S3.11 to S3.18 are dedicated to the processing of an initial request, and the establishment of the profile and session management. The operations S3.21 to S3.28 are dedicated to subsequent requests during an established and opened profile and session management.

In an operation S3.11, the client 100 transmits an initial request. This request may be generated by an application executed at the client 100, such as the illustrated WAP/WEB browser. This initial request comprises information of the UAProf in order to establish a profile and session management according to the concept and embodiments of the present invention. This request is addressed to the server 200.

The server 200 may be an HTTP-based server and the client 100 may be a mobile phone. A gateway/proxy 305 may convert the request or correspondingly a following response. This gateway/proxy 305 is not shown in FIG. 2a since gateway/proxy 305 is not further involved in the operational sequence. In an operation S3.12 the client request is forwarded to the server 200.

In an operation S3.13, the communication interface 231 of the server 200 receives the transmitted client request of client 100.

In an operation S3.14, the session manager 210 of the server 200 may extract the UAProf information from the client request and cache the information in the cache 211. Furthermore, the session manager may generate a referencing and session information uniquely referring to the cached UAProf information and uniquely identifying the session.

In an operation S3.15, the serving component 220 of the server 200 generates a response to the request based on the client request. The serving component 220 may have access to a content 221 for retrieving information necessary to generate the response. The generation of the response further takes into account the UAProf information and adapts the response thereto. The serving component 220 may further generate a response cookie comprising the referencing and session information generated by the session manager 210. The cookie may be appended to the response. Subsequently, the response to the request and the cookie are transmitted by the communication interface 231 to the client 100.

In an operation S3.16, the request is forwarded by proxy/gateway 305 to the client 100.

In an operation S3.17, the client 100 receives the response to its request and the cookie from the server 200. The response may be supplied to the receiving application for further processing. In an operation S3.18, the cookie or the information included in the cookie may be stored in order to be employed for subsequent client requests.

In an operation S3.21, a subsequent request may be generated by an application running on the client 100, for example a WAP/WEB browser requesting a WAP/WEB page for displaying. A cookie is appended to the client request comprising the referencing and session information in order to identify the session. The subsequent request and the cookie are addressed to the server 200 and transmitted thereto.

In an operation S3.22, a proxy/gateway forwards the client request. The forwarding may be operated analogously to the forwarding operation S3.12.

In an operation S3.23, the communication interface 231 of the server 200 receives the request and the cookie.

In an operation S3.24, the session manager 210 of the server 200 may extract the referencing and session information from the cookie, and retrieves correspondingly the profile data from the cache 211, i.e. the previously cached UAProf information.

In an operation S3.25, the serving component 220 of the server 200 generates a response to the request based on the client request. The serving component 220 may have access to a content 221 for retrieving information necessary to generate the response. The generation of the response further takes into account the UAProf information and adapts the response thereto. The serving component 220 may further generate a response cookie comprising the status information with reference to the taking account of the UAProf information and/or referencing and session information in case of a necessary update of the referencing and session information stored at the client 100. The cookie may be appended to the response. Subsequently, the response to the request is transmitted by the communication interface 231 to the client 100.

In an operation S3.26, the request may be forwarded by proxy/gateway 305 to the client 100.

In an operation S3.27, the client 100 receives the response to its request and the cookie from the server 200. The response may be supplied to the receiving application for further processing. In an operation S3.28, the cookie or the information included in the cookie may be stored. The storing may be an update of a previously stored cookie information.

FIG. 3b shows a flow diagram illustrating a timely sequence of the operations with respect to FIG. 2b and according to an embodiment of the invention. The operational sequence shown in FIG. 3b, according to the apparatus and system illustrated in FIG. 2b, corresponds to the client—getaway communication described in FIG. 1a and FIG. 1b. The following description may extend the above-presented description. Therefore references back to the FIG. 2b will be given.

The operations S4.10 to S4.19 are dedicated to the processing of an initial request and the establishment of the profile and session management. The operations S4.20 to S4.29 are dedicated to subsequent requests during an established and opened profile and session management.

In an operation S4.10 the client 100 transmits an initial request. This request may be generated by an application executed at the client 100, such as the illustrated WAP/WEB browser. This initial request comprises information of the UAProf in order to establish a profile and session management according to the concept and embodiments of the present invention. This request is addressed to the server 201.

In an operation S4.11, the communication interface 330 of the gateway/proxy 300 receives the transmitted client request of client 100.

In an operation S4.12, the session manager 310 of the gateway/proxy 300 may extract the UAProf information from the client request and cache the information in the cache 311. Furthermore, the session manager may generate a referencing and session information uniquely referring to the cached UAProf information and uniquely identifying the session.

In an operation S4.13, the client request is forwarded to the server 201. The forwarding may entail generating a server request corresponding to the original client request and/or a conversion of the transfer protocol. The server request also comprises the UAProf information. The communication interface 331 of the gateway/proxy 300 transmits the server request to the server 201.

In an operation S4.14, the communication interface 231 of the server 201 receives the server request.

In an operation S4.15 the serving component 220 of the server 201 generates a server response to the request based on the server request or the client request, respectively. The serving component 220 may have access to a content 221 for retrieving information necessary to generate the server response. The generation of the response further takes into account the UAProf information and adapts the server response thereto. Subsequently, the response to the request is transmitted by the communication interface 231 to the gateway/proxy 300.

In an operation S4.16, the communication interface 331 of the gateway/proxy 300 receives the server response.

In an operation S4.17, a response to the client request may be generated based on the server response. The gateway/proxy 300 may take the UAProf into account and adapt the generated response thereto. It has to be guaranteed that the response to the client request meets the needs and requirements in accordance with the UAProf information of the client 100. The serving component 320 may further generate a response cookie comprising the referencing and session information generated by the session manager 310. The cookie may be appended to the response. Subsequently, the response and the cookie are transmitted by the communication interface 330 to the client 100.

In an operation S4.18, the client 100 receives the response to its request and the cookie from the gateway/proxy 300. The response may be supplied to the receiving application for further processing. In an operation S4.19, the cookie or the information comprised by the cookie may be stored in order to be employed for subsequent client requests.

In an operation S4.20, a subsequent request may be generated by an application running on the client 100, for example a WAP/WEB browser requesting a WAP/WEB page for displaying. A cookie is appended to the client request comprising the referencing and session information in order to identify the session. The subsequent request and the cookie are transmitted to the gateway/proxy 300.

In an operation S4.21, the communication interface 330 of the gateway/proxy 300 receives the transmitted client request of client 100.

In an operation S4.22, the session manager 310 of the gateway/proxy 300 may extract the referencing and session information from the cookie and retrieve correspondingly the profile data from the cache 311, i.e. the previously cached UAProf information.

In an operation S4.23, a server request is generated based on the original client request. The generating may comprise a conversion of the transfer protocol. The server request further comprises the cached UAProf information retrieved in operation S4.22. The communication interface 331 of the gateway/proxy 300 transmits the server request to the server 201.

In an operation S4.24, the communication interface 231 of the server 201 receives the server request.

In an operation S4.25 the serving component 220 of the server 201 generates a server response based on the server request. The serving component 220 may have access to a content 221 for retrieving information necessary to generate the server response. The generation of the response further takes the UAProf information into account and adapts the server response thereto. Subsequently, the response to the request is transmitted by the communication interface 231 to the gateway/proxy 300.

In an operation S4.26, the communication interface 331 of the gateway/proxy 300 receives the server response.

In an operation S4.27, a response to the client request is generated based on the server response. The gateway/proxy 300 may consider the UAProf and may additionally adapt the generated response thereto. It has to be guaranteed that the response to the client request meets the needs and requirements in accordance with the UAProf information of the client 100. The serving component 320 may further generate a response cookie comprising the status information with reference to the taking account of the UAProf information and/or referencing and session information in case of a necessary update of the referencing and session information stored at the client 100. The cookie may be appended to the response. Subsequently, the response to the client request and the cookie are transmitted by the communication interface 330 to the client 100.

In an operation S4.28, the client 100 receives the response to its request and the cookie from the gateway/proxy 300. The response may be supplied to the receiving application for further processing. In an operation S4.29, the cookie or the information included in the cookie may be stored. The storing may be an updating of a previously stored cookie information.

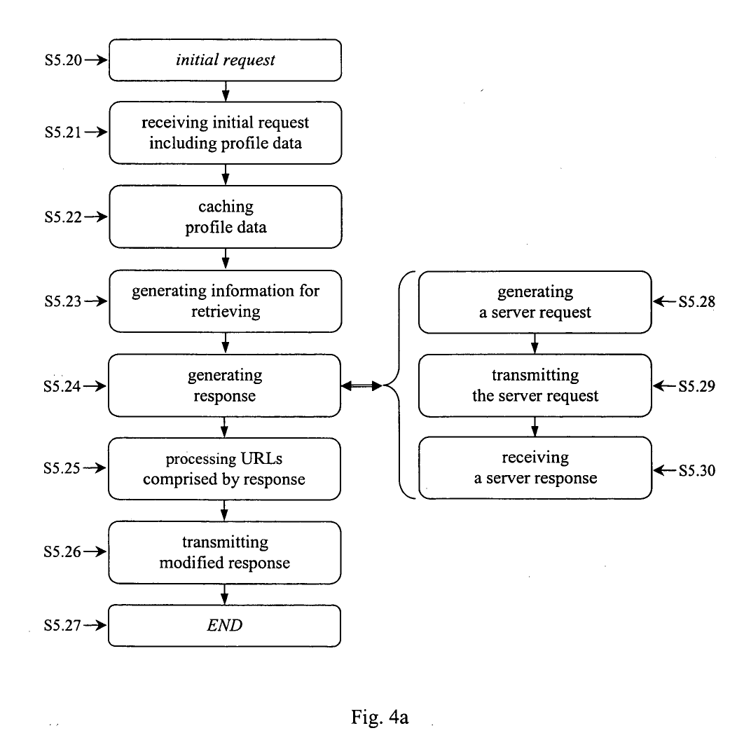

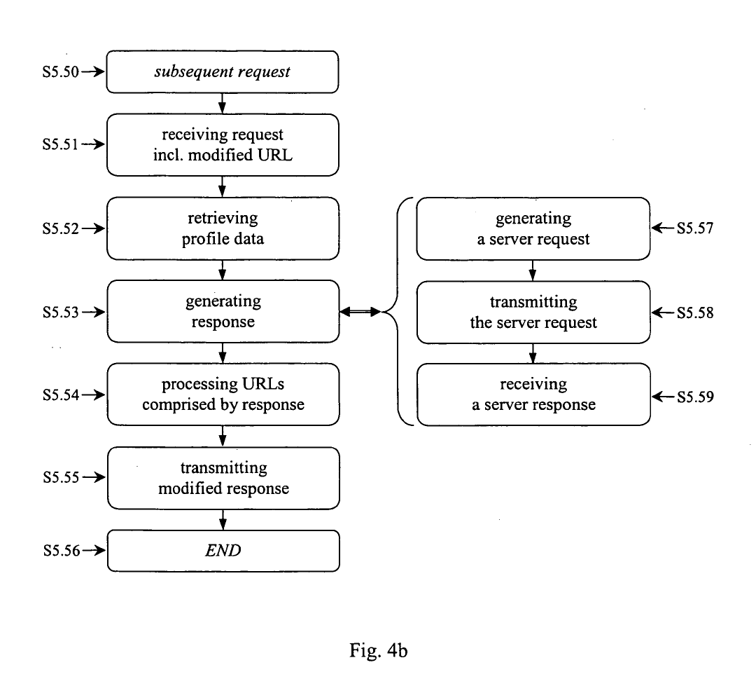

FIG. 4a shows a flow diagram illustrating a sequence of processing operations with respect to the operation of a server and a gateway, respectively, according to an embodiment of the invention. The sequence of processing operations illustrates the establishment of the profile and session management in accordance with an initial client request. Due to the interaction of processing devices within an end-to-end communication chain, the concept of the present invention will be described with reference to a terminal client and a terminal server, as also to a terminal client and an intermediate network device i.e. an interacting gateway or proxy.

Client—Server Communication:

The following operations are dedicated to and operated by a server communicating with a client, both supporting the profile and session management according to an embodiment of the present invention.

In an operation S5.20, the initial request operation is started.

In an operation S5.21, a server receives an initial request. The initial request comprises, according to the description above, user agent profile (UAProf) information. The server recognizes on the basis of the comprised UAProf and due to an original unmodified uniform resource locator (URL) used for addressing the client request, that a session has to be opened and the initial UAProf information has to be established. For example, the request may instruct a server to generate and retransmit a WAP/WEB page in accordance with the provided URL “http://www.nokia.com/main.html”.

In an operation S5.22, the initial UAProf information is cached. The UAProf information may be optionally modified by the server by adding server related UAProf information, reflecting information only available by the server.

In an operation S5.23, referencing and session information is obtained. The referencing information comprises a code sequence by which the cached UAProf information is accessible and retrievable, i.e. this code sequence may be termed as a pointer pointing to the cached UAProf information. Further, the referencing information may additionally code a unique session identification, such that the server may identify a subsequent client request as belonging to this established session.

In an operation S5.24, a response in accordance with the client request is generated. For example, the generated response may comprise following sequence:
<html><body>
<a href=“http://www.nokia.com/page2.hml”>Follow this link to the next page</a>
</body></html>

In an operation S5.25, the uniform resource locators (URL) comprised in the generated response are processed. In order to inform the client of the established session and to put the client in the position to transmit a unique session identifying information upon subsequent requests to the same server, the generated referencing and session information may be appended to the uniform resource locators (URL) included in the generated response. Adding a signaling sequence may further complete the coding of the aforementioned referencing and session information.

According to the above-presented exemplary sequence included in the response, the modification may result in the following sequence:
<html><body>
<a href=“http://www.nokia.com/page2.hml?uaprofidNAWG094719 3=123554”>Follow this link to the next page</a>
</body></html>

Herein, the referencing and session information may be composed of a first part of a sequence “uaprofidNAWG0947193” and a second part of a sequence “123554”. The first part of the sequence may represent the referring information for retrieving the cached profile data, i.e. the UAProf information, whereas the second part of the sequence may represent a session identifier.

In an operation S5.26, the generated response to the request comprising modified URLs is transmitted to the client.

In an operation S5.27, the operational sequence in accordance with the initial client request is finished.

Client—Gateway Communication:

The following operations are dedicated to and operated by an intermediate network device communicating with a client, both supporting the profile and session management according to an embodiment of the present invention. Advantageously, the description of the Client—Gateway Communication may distinguish between a server supporting the profile and session management according to an embodiment of the present invention, and a conventional server that does not support sessions.

In both cases the intermediate network device operates the operations S5.20 to S5.23 in the same manner compared with the aforementioned operations S5.20 to S5.23 referencing to the Client—Server Communication. The operation S5.22 may comprise a modification operation in accordance with the tasks of an intermediate negotiating network device, herein described with reference to an intermediate network device, respectively. The UAProf information may be optionally modified by the intermediate network device by adding server related UAProf information, reflecting information only available by the intermediate network device, e.g. to better meet the needs of the requesting client. The operation S5.24 comprises a plurality of additional operations referring to the server communication.

Profile and Session Managing Server:

In an operation S5.28, a server request is generated based on the client request. The referencing and session information relating to the intermediate network device is removed. Further, the generation of the server request may be a conversion of the client request. The client request may be based on another transfer protocol as the server request. The information contained in the client request may be taken over without modifying the content of the information. For example, a client request is received based on WAP and has to be forwarded to an HTTP based server. Correspondingly, the intermediate network device converts the client request. The comprised user agent profile (UAProf) information is maintained by the generating operation. In case of a prior modification of the UAProf described in operation S5.24, the modified user agent profile (UAProf) information may be included in the generated server request.

In an operation S5.29, the server request is transmitted to the server.

In an operation S5.30, a server response to the request is received. The server has preferably operated the operations S1.20 to S1.27 according to the aforementioned description referring to the Client—Server Communication according to an embodiment of the present invention. URLs contained in the server response may be modified by appending referencing and session information of the UAProf caching and session managing of the server, and correspondingly may comprise a corresponding signaling sequence described above.

In an operation S5.24, the intermediate network device generates a response to the client request based on the server response. The generation may comprise a conversion operation e.g. to convert the server response information coded in a certain transfer protocol into a transfer protocol suitable for communication with the client. The generating operation may take additionally the UAProf information into account according to the version cached by the intermediate network device. For example, the cached UAProf information may be taken into account in case that the generated response does not fulfil all requirements of the client due to an incomplete considering of the UAProf information by the server, e.g. due to lacking server capabilities.

In an operation S5.25, the uniform resource locators (URL) contained in the generated response are processed. In order to inform the client of the established session and to put the client in the position to transmit a unique session identifying information upon subsequent requests to the same server, the generated referencing and session information may be appended to the uniform resource locators (URL) contained in the generated response. Adding a signaling sequence may further complete the coding of the aforementioned referencing and session information. The URLs may comprise now two different referencing and session informations according to the server and the intermediate network device, which do not interfere with each other.

Non-Session Managing Server:

In an operation S5.28, a server request is generated. The generation of the server request is performed analogously to the generating operation S5.28 described above with reference to the profile and session managing server.

In an operation S5.29, the server request is transmitted to the server.

In an operation S5.30, the intermediate network device receives the corresponding server response to the request. According to the capability of the server, the received server response may be based on the transmitted UAProf comprised in the server request or the server may have not considered the provided UAProf.

In an operation S5.24, the generating operation may additionally take the UAProf information into account according to the version cached by the intermediate network device. For example, the cached UAProf information may be taken into account in case that the generated response does not fulfil all requirements of the client due to an incomplete considering of the UAProf information by the server, e.g. due to lacking server capabilities. Particularly, the intermediate network device may take the UAProf information during the generating operation into consideration in case of a server which is not capable to consider the transmitted UAProf information adequately.

The further operations S5.25 and S5.26 are operated analogously to the operation S5.25 and S5.26 described above with reference to the Client—Server Communication.

The following description with reference to FIG. 4b may describe the profile and session managing with respect to subsequent client requests during an established session according to the concept basing on an embodiment of the present invention.

FIG. 4b shows a flow diagram illustrating a sequence of processing operations with respect to the operation of a server and a gateway, respectively, according to an embodiment of the invention. The illustrated sequence will be described in view of client—server communication and client—gateway communication analog to the description with respect to FIG. 4a.

Client—Server Communication:

In an operation S5.50, a subsequent request operation is started. A corresponding profile and session management is opened or established and the corresponding access information is available to client and server.

In an operation S5.51, the server receives a subsequent request from the client. The subsequent client request comprises a URL including referencing and session information. The session information and the referencing information allows the server to retrieve the information cached, i.e. the UAProf information transmitted at the establishment and opening of the corresponding client related session. Therefore, referencing and session information identifies uniquely the client and references uniquely the cached UAProf information. Additional control sequences may be included in the URL comprising the referencing and session information.

In an operation S5.52, the cached profile data are received. Particularly, cached UAProf information is retrieved.

In an operation S5.53, a response in accordance with the client request is generated. The generating operation takes into account the retrieved UAProf information by e.g. adapting or modifying the response to meet the needs and requirements of the client defined in the UAProf information.

In an operation S5.54, the uniform resource locators (URL) contained in the generated response are processed. In order to inform the client of the established session and to put the client in the position to transmit a unique session identifying information upon subsequent requests to the same server, the generated referencing and session information may be appended to the uniform resource locators (URL) contained in the generated response. Adding a signaling sequence may further complete the coding of the aforementioned referencing and session information.

In an operation S5.55, the generated response to the request, comprising modified URLs, is transmitted to the client.

In an operation S5.56, the operational sequence in accordance with the initial client request is finished.

Client—Gateway Communication:

According to the following description, the operations S5.50 and S5.53 to S5.55 are operated by an intermediate network device in the same manner as with the aforementioned operations S5.30 and S5.25 to S5.26 referencing to the Client—Server Communication.

Profile and Session Managing Server:

In order to identify the session managed by a subsequent server, the request may have to comprise additional referencing and session information in accordance with the profile and session management of the server, in order to enable the retrieval of the profile data by the server. Several referencing and session information according to profile and session management of different network devices can be coded within the modified URL, e.g. by appending successively the individual network relating referencing and session information.

In an operation S5.57, a server request is generated. The server request is based on the client request. The referencing and session information included in the uniform resource locator (URL) and relating to the profile and session management of the intermediate network device is removed. The resulting uniform resource locator (URL) is employed for the addressing of the server request. The generating operation may be a conversion process analog to the operation S5.28 illustrated in FIG. 1a.

In an operation S5.58, the server request is transmitted to the server.

The following operations S5.59 and S5.53 are operated analogously to the operation S5.30 and S5.24 described in accordance with the client—gateway communication section of the profile and session managing server.

In an operation S5.59, a server request is received. The server has preferably operated the operations S5.50 to S5.56 according to the aforementioned description referring to a server according to an embodiment of the invention. Correspondingly, the server response to the request comprises modified URLs including referencing and session information of the UAProf caching and session management of the server and optionally a signaling sequence described above.

In an operation S5.53, the intermediate network device generates a response to the client request based on the server response. The generation may comprise a conversion operation e.g. to convert the server response information coded in a certain transfer protocol into a transfer protocol suitable for communication with the client. The generating operation may additionally take the UAProf information into account according to the version cached by the intermediate network device. Referencing and session information of both the intermediate network device and the server is available.

In an operation S5.54, the uniform resource locators (URL) contained within the generated response are processed. In order to inform the client of the established session and to put the client in the position to transmit a unique session identifying information upon subsequent requests to the same server, the generated referencing and session information may be appended to the uniform resource locators (URL) contained in the generated request response. Adding a signaling sequence may further complete the coding of the aforementioned referencing and session information. The URLs may comprise now two different referencing and session information according to the server and the intermediate network device, which do not interfere with each other.

In an operation S5.55, the response is transmitted to the client.

Non-Session Managing Server:

The following operations S5.57 to S5.59 and S5.54 to S5.55 are operated analogously to the operations S5.28 to S5.30 and S5.24 to S5.26 described in accordance with the client—gateway communication section of a non-session managing server. Correspondingly, the description may be referred to above at the referenced section.

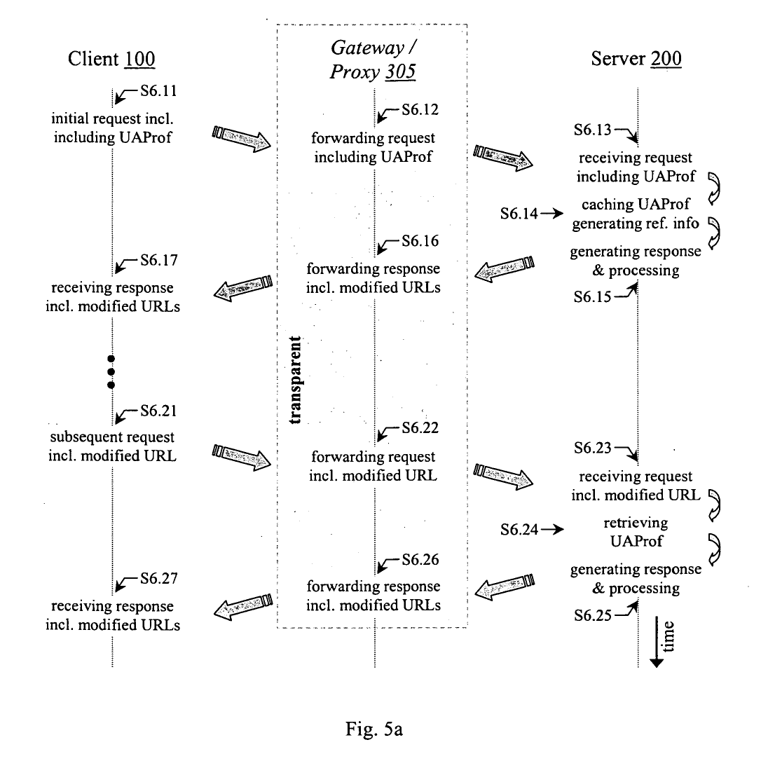

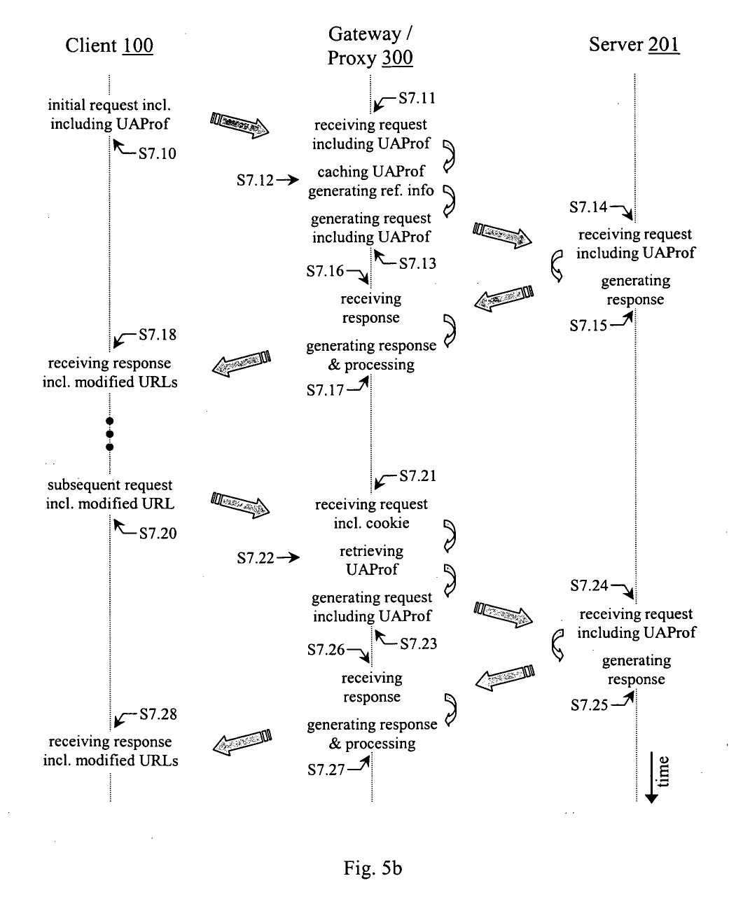

FIG. 5a shows a flow diagram illustrating a sequence of the operations with respect to FIG. 2a and according to an embodiment of the invention. The operational sequence shown in FIG. 5a according to the apparatus and system illustrated in FIG. 2a corresponds to the client—server communication described in FIG. 4a and FIG. 4b. The following description may extend the above-presented description. Therefore references back to the FIG. 2a will be given.

The operations S6.11 to S6.17 are dedicated to the processing of an initial request and the establishment of the profile and session management. The operations S6.21 to S6.27 are dedicated to subsequent requests during an established and opened profile and session management.

In an operation S6.11 the client 100 transmits an initial request. This request may be generated by an application executed at the client 100, such as the illustrated WAP/WEB browser. This initial request comprises information of the UAProf in order to establish a profile and session management according to the concept and embodiments of the present invention. This request is addressed to the server 200.

The server 200 may be an HTTP-based server and the client 100 may be a mobile phone. A gateway/proxy 305 may convert the request or correspondingly a following response. This gateway/proxy 305 is not shown in FIG. 2a since gateway/proxy 305 is not further involved in the operational sequence. In an operation S6.12 the client request is forwarded to the server 200.

In an operation S6.13, the communication interface 231 of the server 200 receives the transmitted client request of client 100.

In an operation S6.14, the session manager 210 of the server 200 may extract the UAProf information from the client request and cache the information in the cache 211. Further, the session manager may generate a referencing and session information uniquely referring to the cached UAProf information and uniquely identifying the session.

In an operation S6.15, the serving component 220 of the server 200 generates a response to the request based on the client request. The serving component 220 may have access to a content 221 for retrieving information necessary to generate the response. The generation of the response further takes the UAProf information into account and adapts the response thereto. The URLs contained in the response are processed. The referencing and session information is appended to each URL.

In an operation S6.16, the request is forwarded by the proxy/gateway 305 to the client 100.

In an operation S6.17, the client 100 receives the response to its request from the server 200. The response may be supplied to the receiving application for further processing.

In an operation S6.21, a subsequent request may be generated by an application running on the client 100, for example a WAP/WEB browser requesting a WAP/WEB page for displaying. The modified uniform resource locator (URL) of the client request comprises the referencing and session information in order to identify the session. The subsequent request is transmitted to the server 200.

In an operation S6.22, a proxy/gateway forwards the client request. The forwarding may be operated analogously to the forwarding operation S3.12.

In an operation S6.23, the communication interface 230 of the server 200 receives the request.

In an operation S6.24, the session manager 210 of the server 200 may extract the referencing and session information from the URL of the client request, and retrieves correspondingly the profile data from the cache 211, i.e. the previously cached UAProf information.

In an operation S6.25, the serving component 220 of the server 200 generates a response to the request based on the client request. The serving component 220 may have access to a content 221 for retrieving information necessary to generate the response. The generation of the response further takes the UAProf information into account and adapts the response thereto. Additionally, the serving component 220 further processes the URLs contained in the generated response by appending referencing and session information. Subsequently, the response to the request is transmitted by the communication interface 230 to the client 100.

In an operation S6.26, the request may be forwarded by the proxy/gateway 305 to the client 100.

In an operation S6.27, the client 100 receives the request response from the server 200. The response may be supplied to the receiving application for further processing.

FIG. 5b shows a flow diagram illustrating a timely sequence of the operations with respect to FIG. 2b and according to an embodiment of the invention. The operational sequence shown in FIG. 5b according to the apparatus and system illustrated in FIG. 2b corresponds to the client—gateway communication described in FIG. 4a and FIG. 4b. The following description may extend the above presented description. Therefore references back to the FIG. 2b will be given.

The operations S7.10 to S7.18 are dedicated to the processing of an initial request and the establishment of the profile and session management. The operations S7.20 to S7.28 are dedicated to subsequent requests during an established and opened profile and session management.

In an operation S7.10 the client 100 transmits an initial request. This request may be generated by an application executed at the client 100, such as the illustrated WAP/WEB browser. This initial request comprises UAProf information in order to establish a profile and session management according to the concept and embodiments of the present invention. This request is addressed to the server 201.

In an operation S7.11, the communication interface 330 of the gateway/proxy 300 receives the transmitted client request of client 100.

In an operation S7.12, the session manager 310 of the gateway/proxy 300 may extract the UAProf information from the client request and cache the information in the cache 311. Further, the session manager may generate a referencing and session information uniquely referring to the cached UAProf information and uniquely identifying the session.

In an operation S7.13, the client request is forwarded to the server 201. The forwarding may comprise a generating of a server request corresponding to the original client request and/or a conversion of the transfer protocol. The server request also comprises the UAProf information. The communication interface 331 of the gateway/proxy 300 transmits the server request to the server 201.

In an operation S7.14, the communication interface 231 of the server 201 receives the server request.

In an operation S7.15 the serving component 220 of the server 201 generates a server response to the request based on the server request or the client request, respectively. The serving component 220 may have access to a content 221 for retrieving information necessary to generate the server response. The generation of the response further takes the UAProf information into account and adapts the server response thereto. Subsequently, the response to the request is transmitted by the communication interface 231 to the gateway/proxy 300.

In an operation S7.16, the communication interface 331 of the gateway/proxy 300 receives the server request response.

In an operation S7.17, a response to the client request may be generated based on the server response. The gateway/proxy 300 may take the UAProf into account and adapt the generated response thereto. It has to be guaranteed that the response to the client request meets the needs and requirements in accordance with the UAProf information of the client 100. The serving component 320 further processes the URLs contained in the generated response. The referring and session information generated by the session manager 310 may be appended to the comprised URLs. Subsequently, the response is transmitted by the communication interface 330 to the client 100.

In an operation S7.18, the client 100 receives the request response from the gateway/proxy 300. The response may be supplied to the receiving application for further processing. Further subsequent responses may be based on the modified URLs comprised in the received response.

In an operation S7.20, a subsequent request may be generated by an application running on the client 100, for example a WAP/WEB browser requesting a WAP/WEB page for displaying. The request may be initiated by selecting a modified URL for following the link. The subsequent request is transmitted to the gateway/proxy 300.

In an operation S7.21, the communication interface 330 of the gateway/proxy 300 receives the transmitted client request of client 100.

In an operation S7.22, the session manager 310 of the gateway/proxy 300 may extract the referencing and session information from the URL contained within the client request, and retrieves correspondingly the profile data from the cache 311, i.e. the previously cached UAProf information.

In an operation S7.23, a server request is generated based on the original client request. The generation may entail a conversion of the transfer protocol. The server request further comprises the cached UAProf information retrieved in operation S7.22. The URL may be set to its original state by removing the referencing and session information referring to the profile and session management of the gateway/proxy 300. The communication interface 331 of the gateway/proxy 300 transmits the server request to the server 201.

In an operation S7.24, the communication interface 230 of the server 201 receives the server request.

In an operation S7.25 the serving component 220 of the server 201 generates a server response to the request based on the server request. The serving component 220 may have access to a content 221 for retrieving information necessary to generate the server response. The generation of the response further takes the UAProf information into account and adapts the server response thereto. Subsequently, the response to the request is transmitted by the communication interface 231 to the gateway/proxy 300.

In an operation S7.26, the communication interface 331 of the gateway/proxy 300 receives the server response.

In an operation S7.27, a response to the client request is generated based on the server response. The gateway/proxy 300 may take the UAProf into consideration and may additionally adapt the generated response thereto. It has to be guaranteed that the response to the client request meets the needs and requirements in accordance with the UAProf information of the client 100. The serving component 320 further processes the URLs contained within the generated client response. The referring and session information generated by the session manager 310 may be appended to the comprised URLs. Subsequently, the response to the request is transmitted by the communication interface 330 to the client 100.

In an operation S7.28, the client 100 receives the response to its request comprising modified URL from the gateway/proxy 300. The response may be supplied to the receiving application for further processing.

This specification contains the description of implementations and embodiments of the present invention with the help of examples. A person skilled in the art will appreciate that the present invention is not restricted to details of the embodiments presented above, and that the invention can be also implemented in another form without deviating from the characteristics of the invention. The embodiment presented above should be considered as illustrative, but not restricting. Thus, the possibilities of implementing and using the invention are only restricted to the enclosed claims. Consequently, various options of implementing the invention as determined by the claims, including equivalent implementations, also belong to the scope of the invention.

1. Method for providing profile data to a requesting device, comprising the steps of:
receiving (S1.11) a request and an associated cookie from said requesting device (100), said cookie comprising information for retrieving said profile data,
retrieving (S1.12) said profile data,
generating (S1.13) a response in accordance with said request, said response being based on said profile data;
generating (S1.13) a response cookie comprising session information, and
transmitting (S1.14) said response and response cookie to said requesting device (100).

2. Method for providing profile data to a requesting device, comprising the steps of:
receiving (S5.51) a request for data from said requesting device (100), wherein said request has a uniform resource locator (URL) referring to said data being requested and comprising information for retrieving profile data,
retrieving (S5.52) said profile data,
generating (S5.53) a response in accordance with said request, wherein said response is based on said profile data and includes a plurality of uniform resource locators (URLs),
processing (S5.54) said uniform resource locators (URLs) by including therein information for retrieving profile data, and
transmitting (S5.55) said response to said requesting device (100).

3. Method according to claim 1, wherein said profile data are available for being retrieved for a certain period of time.

4. Method according to claim 3, wherein said period of time starts with the initial receiving of said profile data.

5. Method according to claim 4, wherein said period of time is terminated with the removal of said profile data.

6. Method according to claim 1, wherein said step of generating a response further comprises the steps of;
generating (S1.27, S1.16, S5.28, S5.57) a server request based on the client request,
transmitting (S1.28, S1.17, S5.29, S5.58) said server request,
receiving (S1.29, S1.18, S5.30, S5.59) a server response in accordance with said server request and
generating (S1.24, S1.13, S5.24, S5.53) a response based on said server response.

7. Method according to claim 1, wherein said request is a request to a WEB- or WAP-server.

8. Method according to 1, wherein said method is applicable to the hypertext transport protocol (HTTP).

9. Software tool for providing profile data, comprising program code portions for carrying out the operations of claim 1 when said program is implemented in a computer program for executing on a computer or a network device.

10. Computer program for providing profile data, comprising program code section for carrying out the operations of claim 1 when said program is run on a computer or a network device.

11. Computer program product for providing profile data, wherein said computer program product comprises program code sections stored on a computer readable medium for carrying out the method of claim 1 when said program product is run on a computer or network device.

12. Network device for providing profile data, said network device (200, 300) comprising
a communication interface (231, 330, 331) for receiving a request and a cookie from a requesting device (100) and for transmitting a response and a response cookie to said requesting device (100),
a session manager (210, 310) for providing profile data, wherein said session manager comprises a cache (211, 311) for caching said profile data and is adapted for retrieving said profile data from said cache (211, 311) in accordance with information comprised in said cookie; and for generating said response cookie comprising session information and
a serving component (220, 320) for generating said response based on said request, wherein said serving component (220, 320) is adapted to take said profile data into account.

13. Network device for providing profile data, said network device (200, 300) comprising
a communication interface (231, 330, 331) for receiving a request from a requesting device (100) and for transmitting a response to said requesting device (100),
a session manager (210, 310) for providing profile data, wherein said session manager comprises a cache (211, 311) for caching said profile data and is adapted for retrieving said profile data from said cache (211, 311) in accordance with information comprised in a uniform resource locator (URL) of said request and
a serving component (220, 320) for generating said response based on said request and for processing uniform resource locators (URLs) comprised in said response by including therein information for retrieving said profile data from said cache (211, 311), wherein said serving component (220, 320) is adapted to take said profile data into account.

14. Network device according to claim 12, wherein said network device (200, 300) is a server network device (200).

15. Network device according to claim 12, said network device (200, 300) further comprising:
a communication interface (231, 330, 331) for transmitting a server request to a server network device (201) and receiving a server response from said server network device (201) and
a serving component (220, 320) for generating a server request and generating said response additionally based on said server response.

16. Network device according to claim 12, wherein said network device (200, 300) is a proxy network device (300) or a gateway network device (300).

17. System for providing profile data, comprising
a requesting device (100) and
a network device (200) according to claim 14.

18. System for providing profile data, comprising
a requesting device (100),
an intermediate network device (300) according to claim 16 and
a server (201),
wherein said requesting device (100) is adapted to communicate via said intermediate network device (300) with said server (201).

19. Method according to claim 2, wherein said profile data are available for being retrieved for a certain period of time.

20. Method according to claim 19, wherein said period of time starts with the initial receiving of said profile data.

21. Method according to claim 20, wherein said period of time is terminated with the removal of said profile data.

22. Method according to claim 2, wherein said step of generating a response further comprises the steps of:
generating (S1.27, S1.16, S5.28, S5.57) a server request based on the client request,
transmitting (S1.28, S1.17, S5.29, S5.58) said server request,
receiving (S1.29, S1.18, S5.30, S5.59) a server response in accordance with said server request and
generating (S1.24, S1.13, S5.24, S5.53) a response based on said server response.

23. Computer program for providing profile data, wherein said computer program is stored on a computer readable medium for carrying out the method of claim 2.

24. Network device according to claim 13, wherein said method device is a server network device (200).

25. Network device according to claim 13, said network device (200, 300) further comprising
a communication interface (231, 330, 331) for transmitting a server request to a server network device (201) and receiving, a server response from said server network device (201) and
a serving component (220, 320) for generating a server request and generating said response additionally based on said server response.

26. Network device according to claim 13, wherein said network device (200, 300) is a proxy network device (300) or a gateway network device (300).

27. System for providing profile data, comprising
a requesting device (100) and
a network device (200) according to claim 25.

28. System for providing profile data, comprising
a requesting device (100),
an intermediate network device (300) according to claim 26 and
a server (201),
wherein said requesting device (100) is adapted to communicate via said intermediate network device (300) with said server (201).
